(19) United States
(12) Patent Application Publication
(10) Pub. No.: US 2021/0066937 A1
(43) Pub. Date: Mar. 4, 2021

(54) KINETIC ENERGY CHARGING DEVICE

(71) Applicant: Irwin Girven, San Francisco, CA (US)

(72) Inventor: Irwin Girven, San Francisco, CA (US)

(21) Appl. No.: 17/000,302

(22) Filed: Aug. 22, 2020

Related U.S. Application Data
(60) Provisional application No. 62/892,389, filed on Aug. 27, 2019.

(51) Int. Cl. H02J 7/00; H02K 7/18; A42B 1/24

(52) U.S. Cl. CPC H02J 7/0048; A42B 1/24; H02K 7/1853

(57) ABSTRACT

A kinetic energy charging device, including a charging portion to be disposed at a first end on at least a portion of a hat to receive a connection from an external device, such that the charging portion charges the external device, and a kinetic energy generating portion disposed on at least a portion of a second end of the charging portion, the kinetic energy generating portion including at least one propeller to generate energy to be stored within the charging portion in response to rotation of the at least one propeller.

### CROSS REFERENCE TO RELATED APPLICATION

This application claims the benefit of, and incorporates by reference, U.S. provisional patent application Ser. No. 62/892,389, entitled “Kinetic Energy Charging Device,” which was filed on Aug. 27, 2019.

### BACKGROUND

### 1. Field

The present general inventive concept relates generally to a charging device, and particularly, to a kinetic energy charging device.

### 2. Description of the Related Art

Various technologies today include handheld smartphones and other electronic devices that require consistent charging for daily use. Most people tend to rely on having multiple wires and/or charging devices connected to an electrical outlet, as a means for providing constant power to the electronic devices.

Charging devices connected to an electrical outlet are required to remain stationary while charging. However, most electronic devices are mobile. As such, a mobile device that has to stay stationary just to charge is a major inconvenience for any mobile device users.

Therefore, there is a need for a charging device that is portable and is not dependent on remaining connected to an electrical outlet.

### SUMMARY

The present general inventive concept provides a kinetic energy charging device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a kinetic energy charging device, including a charging portion to be disposed at a first end on at least a portion of a hat to receive a connection from an external device, such that the charging portion charges the external device, and a kinetic energy generating portion disposed on at least a portion of a second end of the charging portion, the kinetic energy generating portion including at least one propeller to generate energy to be stored within the charging portion in response to rotation of the at least one propeller.

The charging portion may include a main body, and a squatchee-receiving divot disposed on at least a portion of a base of the main body to receive a squatchee of the hat, such that the main body is disposed behind the squatchee.

The at least one propeller may include at least one propeller light disposed on at least a portion of an edge of the at least one propeller.

The at least one propeller light may illuminate in response to a level of charge of the charging portion in a regular mode.

The at least one propeller light may pulsate in synchrony with music received from the external device on the charging portion in a disco mode.

The kinetic energy charging device may further include a magnetic disc to magnetically connect through the hat to the charging portion to prevent the charging portion from falling off the hat.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front isometric view of a kinetic energy charging device, according to an exemplary embodiment of the present general inventive concept;

FIG. 1B illustrates a rear isometric view of the kinetic energy charging device, according to an exemplary embodiment of the present general inventive concept;

FIG. 2 illustrates a front isometric view of the kinetic energy charging device disposed on a hat, according to an exemplary embodiment of the present general inventive concept; and

FIG. 3 illustrates a bottom view of the kinetic energy charging device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Kinetic Energy Charging Device 100

Charging Portion 110

Main Body 111

Base 111a

Squatchee-Receiving Divot 111a1

Battery 112

Charging Port 113

Light 114

Speaker 115

Mode Button 116

Power Button 117

Solar Cell 118

Kinetic Energy Generating Portion 120

First Propeller 121

Propeller Light 121a

Second Propeller 122

Propeller Light 122a

Magnetic Disc 130

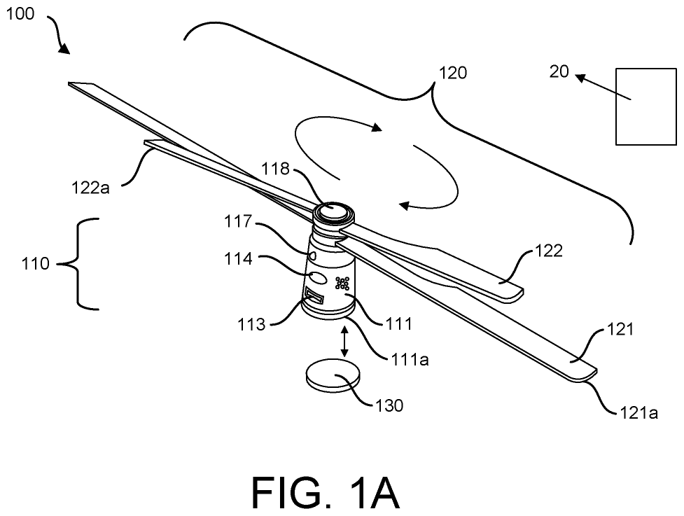

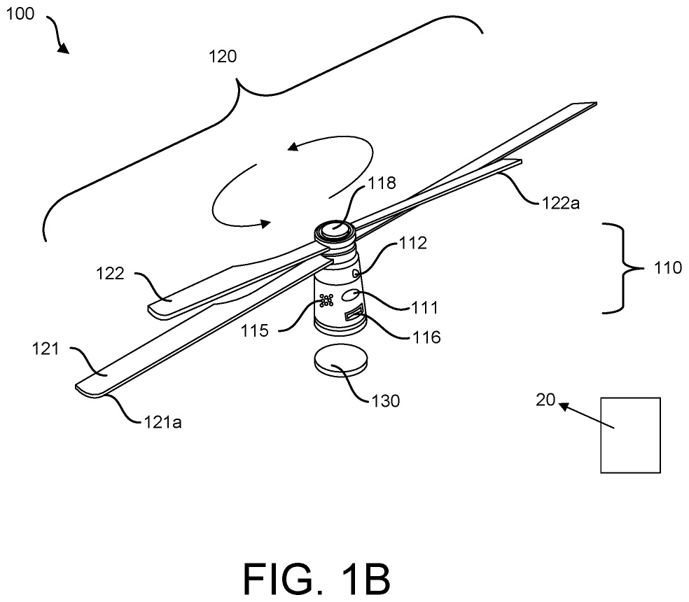

FIG. 1A illustrates a front isometric view of a kinetic energy charging device 100, according to an exemplary embodiment of the present general inventive concept.

FIG. 1B illustrates a rear isometric view of the kinetic energy charging device 100, according to an exemplary embodiment of the present general inventive concept.

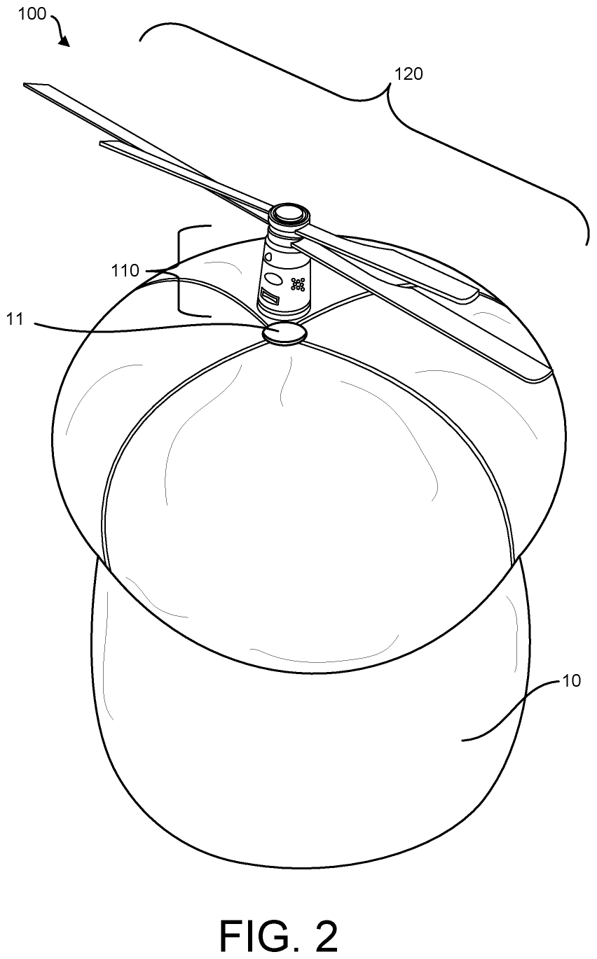

FIG. 2 illustrates a front isometric view of the kinetic energy charging device 100 disposed on a hat 10, according to an exemplary embodiment of the present general inventive concept.

The kinetic energy charging device 100 may be constructed from at least one of metal, plastic, wood, glass, and rubber, etc., but is not limited thereto.

The kinetic energy charging device 100 may include a charging portion 110, a kinetic energy generating portion 120, and magnetic disc 130, but is not limited thereto.

The charging portion 110 may include a main body 111, a battery 112, a charging port 113, a light 114, a speaker 115, a mode button 116, a power button 117, and a solar cell 118, but is not limited thereto.

Referring to FIGS. 1A and 1B, the main body 111 is illustrated to have a substantially cylindrical shape. However, the main body 111 may be a rectangular prism, rectangular, circular, conical, pentagonal, hexagonal, octagonal, or any other shape known to one of ordinary skill in the art, but is not limited thereto.

The main body 111 may include a base 111a, but is not limited thereto.

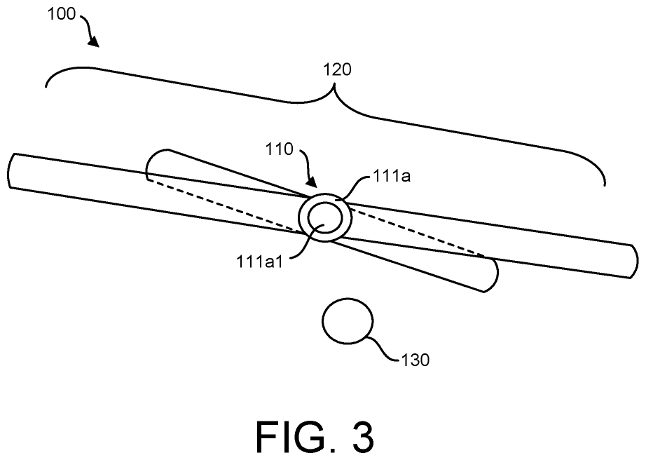

FIG. 3 illustrates a bottom view of the kinetic energy charging device 100, according to an exemplary embodiment of the present general inventive concept.

The base 111a may include a squatchee-receiving divot 111a1, but is not limited thereto.

Referring to FIGS. 1A through 2, the base 111a may be disposed on at least a portion of a first end of the main body 111. The base 111a may be a substantially planar surface, such that the main body 111 may be disposed on another planar surface. For example, the base 111a may be disposed on at least a portion of the hat 10. Specifically, the main body 111 may be disposed on at least a portion of the hat 10 behind a squatchee 11 of the hat 10 via the base 111a.

Alternatively, the main body 111 may be disposed on at least a portion of the squatchee 11 of the hat 10. Specifically, the squatchee-receiving divot 111a1 may receive the squatchee 11 of the hat 10 therein, such that the main body 111 may be disposed thereupon.

The battery 112 may include lithium-ion, nickel cadmium, nickel metal hydride, alkaline, etc., but is not limited thereto.

The charging port 113 may include a USB port and/or a DC port, but is not limited thereto.

The light 114 may include an incandescent bulb and/or an LED bulb, but is not limited thereto.

The light 114 may illuminate based on operation modes of the kinetic energy charging device 100. Specifically, the light 114 may illuminate at least one first color, at least one second color, and/or a plurality of colors based on the operation modes. The operation modes may include a regular mode and a disco mode, but is not limited thereto.

For example, in the regular mode, the light 114 may illuminate bright white in response to the battery 112 being fully charged and/or glowy green in response to the battery 112 being low on charge. In other words, the light 114 may pulse the glowy green in response to the battery 112 being low on charge. Alternatively, the light 114 may pulse the plurality of colors in response to the kinetic energy charging device 100 being set to the disco mode.

The speaker 115 may be a wireless speaker to remotely connect to an external device 20. As such, the speaker 115 may communicate to the external device 20 via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication.

The speaker 115 may receive an audio signal from the external device 20 to emit a sound, such as music therefrom. In other words, the speaker 115 may emit music in response to receiving the audio signal from the external device 20. Additionally, the kinetic energy charging device 100 may play the music from the speaker 115 subsequent to activating the disco mode.

The mode button 116 may be depressed a first time to activate the regular mode, and a second time to activate the disco mode. As such, the kinetic energy charging device 100 may alternate between modes via the mode button 116.

The power button 117 may include a button light disposed within at least a portion thereof. The power button 117 may be depressed a first time to turn on the disco mode, and a second time to turn off the disco mode. The button light may illuminate in response to the power button 117 turning on and/or off the disco mode. Also, the kinetic energy charging device 100 may not play music from the speaker 115 while the kinetic energy charging device 100 is off.

The solar cell 119 may be disposed at a second end of the main body 111. The solar cell 119 may receive light from an external light source, such as the Sun, to convert the light into energy. The solar cell 119 may be connected to the battery 112, such that the battery 112 may store the converted energy therein.

The external device 20 may be connected to the charging port 113 to receive power from the battery 112. In other words, the battery 112 may charge the external device 20 in response to connecting the external device 20 to the charging port 113, and the battery 112 being at least partially charged.

The kinetic energy generating portion 120 may include at least one first propeller 121 and at least one second propeller 122, but is not limited thereto.

The kinetic energy generating portion 120 may be disposed near the second end of the main body 111. Specifically, the at least one first propeller 121 and/or the at least one second propeller 122 may be disposed near the second end of the main body 111.

The at least one first propeller 121 and/or the at least one second propeller 122 may rotate in response to wind blowing thereupon. The rotation of the at least one first propeller 121 and/or the at least one second propeller 122 may generate energy to be stored in the battery 112. In other words, kinetic energy may be generated in response to the rotation of the at least one first propeller 121 and/or the at least one second propeller 122, such that the battery 112 may store the kinetic energy therein. Furthermore, the rotation of the at least one first propeller 121 and/or the at least one second propeller 122 operates similar to a windmill and/or a turbine to generate energy.

The at least one first propeller 121 may include a propeller light 121a, but is not limited thereto.

The at least one second propeller 122 may include a propeller light 122a, but is not limited thereto.

The propeller light 121a of the at least one first propeller 121 and/or the propeller light 122a of the at least one second propeller 122 may illuminate in response to a level of charge of the battery 112. Specifically, the propeller light 121a of the at least one first propeller 121 and/or the propeller light 122a may illuminate brightly at a maximum level of charge of the battery 112. However, the propeller light 121a of the at least one first propeller 121 and/or the propeller light 122a may decrease in brightness of illumination with respect to the illumination at the maximum level of charge of the battery 112, such that the propeller light 121a of the at least one first propeller 121 and/or the propeller light 122a may pulsate in response to a critical level of charge of the battery 112. In other words, the pulsing light of the propeller light 121a of the at least one first propeller 121 and/or the propeller light 122a may indicate a necessity of the battery 112 to be recharged.

As such, the propeller light 121a of the at least one first propeller 121 and/or the propeller light 122a may operate similar to the light 114, as described above.

Also, the propeller light 121a of the at least one first propeller 121 and/or the propeller light 122a may pulse in synchrony with the music in response to music being played from the speaker 115.

The magnetic disc 130 may be magnetically connected to the base 111a of the main body 111 to prevent the main body 111 from falling off the hat 10 and/or another surface. Alternatively, the base 111a may be a magnet to magnetically connect to the magnetic disc 130 to prevent the main body 111 from falling off the hat 10 and/or the another surface.

Therefore, the kinetic energy charging device 100 may charge an electrical device without having to remain stationary and/or connecting the electrical device to an electrical outlet. Furthermore, the kinetic energy charging device 100 may entertain people nearby using the speaker 115 to connect to the external device 20, such that music may be played therefrom.

The present general inventive concept may include a kinetic energy charging device 100, including a charging portion 110 to be disposed at a first end on at least a portion of a hat 10 to receive a connection from an external device 20, such that the charging portion 110 charges the external device 20, and a kinetic energy generating portion 120 disposed on at least a portion of a second end of the charging portion 110, the kinetic energy generating portion 120 including at least one propeller to generate energy to be stored within the charging portion 110 in response to rotation of the at least one propeller.

The charging portion 110 may include a main body 111, and a squatchee-receiving divot 111a1 disposed on at least a portion of a base 111 of the main body 111 to receive a squatchee 11 of the hat 10, such that the main body 111 is disposed behind the squatchee 11.

The at least one propeller may include at least one propeller light disposed on at least a portion of an edge of the at least one propeller.

The at least one propeller light may illuminate in response to a level of charge of the charging portion 110 in a regular mode.

The at least one propeller light may pulsate in synchrony with music received from the external device 20 on the charging portion 110 in a disco mode.

The kinetic energy charging device 100 may further include a magnetic disc 130 to magnetically connect through the hat 10 to the charging portion 110 to prevent the charging portion 110 from falling off the hat 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A kinetic energy charging device, comprising:
a charging portion to be disposed at a first end on at least a portion of a hat to receive a connection from an external device, such that the charging portion charges the external device; and
a kinetic energy generating portion disposed on at least a portion of a second end of the charging portion, the kinetic energy generating portion comprising:
at least one propeller to generate energy to be stored within the charging portion in response to rotation of the at least one propeller.

2. The kinetic energy charging device of claim 1, wherein the charging portion comprises:
a main body; and
a squatchee-receiving divot disposed on at least a portion of a base of the main body to receive a squatchee of the hat, such that the main body is disposed behind the squatchee.

3. The kinetic energy charging device of claim 1, wherein the at least one propeller comprises:
at least one propeller light disposed on at least a portion of an edge of the at least one propeller.

4. The kinetic energy charging device of claim 3, wherein the at least one propeller light illuminates in response to a level of charge of the charging portion in a regular mode.

5. The kinetic energy charging device of claim 3, wherein the at least one propeller light pulsates in synchrony with music received from the external device on the charging portion in a disco mode.

6. The kinetic energy charging device of claim 1, further comprising:
a magnetic disc to magnetically connect through the hat to the charging portion to prevent the charging portion from falling off the hat.
